(19) United States
(12) Patent Application Publication
(10) Pub. No.: US 2002/0056213 A1
(43) Pub. Date: May 16, 2002

(54) Greeting cards holder

(76) Inventor: Lambert Van Der Meer, Middenmeer (NL)

Correspondence Address: YOUNG & THOMPSON, 745 SOUTH 23RD STREET 2ND FLOOR, ARLINGTON, VA, 22202

(21) Appl. No.: 09/988,564

(22) Filed: Nov. 20, 2001

Related U.S. Application Data
(63) Continuation of application No. PCT/NL00/00332, filed on May 17, 2000.

(30) Foreign Application Priority Data
May 21, 1999 (NL) 1012129

(51) Int. Cl. G09F 1/10

(52) U.S. Cl. 40/124

(57) ABSTRACT

Assembly for displaying cards, such as greeting cards, for instance Christmas cards or birth congratulatory cards, includes a number of card holders suitable for several cards, that are situated above each other and at a distance from each other, and elements for connecting the card holders one to the other as well as elements for hanging the assembly on a wall. The card holders are preferably provided with elements for supporting the cards.

The invention relates to an assembly for holding several cards, such as greeting cards and post cards.

On special occasions and public holidays it is not unusual to receive greeting cards from family, friends and acquaintances and/or relations. Special occasions may the birth of a child or passing an exam, whereas public holidays particularly regard Christmas and New Year. Furthermore many cards will be received in the summer holiday period.

Usually the number of cards received—in a relatively short period of time—will be quite large: during Christmas it may concern as many as dozens of cards.

The receiver of the cards would usually want to display the cards in a visible manner. This will not cause a problem with only a few cards. The possibilities however appear to be small for a large number of cards: the surface of a cupboard or the length of a ledge of panelling will then be too small.

In order to nonetheless display all cards, the receiver may use a cord, which is hung between two walls and from which the cards are hung with the help of little pegs. Tightening a cord—because of concrete walls— is not always possible. Elderly people often do no longer have the dexterity to realize such an arrangement. Another disadvantage is that the cord with the cards hung from it may be a visual or physical impediment in the (living) room where it is hung.

It is also known to provide a cardboard or fabric card holder with a number of slits or bags in which the cards can be placed. Their capacity however is limited and the cards are often placed in little groups into the slits. The cardboard card holder moreover is difficult to store away and additionally may be damaged easily.

The invention now has the objective to improve on this, an to that end provides an assembly for displaying cards, such as greeting cards, comprising a number of card holders suitable for several cards, which card holders are situated above each other and at a distance from each other, and means for connecting the card holders one to the other as well as means for hanging the assembly on a wall.

With the assembly according to the invention many cards, in series of cards adjacent to each other and held in a stable manner in the card holders, can be placed above each other, and in that way be hung against a wall. A matrix display is then as it were realised.

Preferably the card holders are provided with means for supporting the cards, so that particular clamping means for vertically keeping the cards in their places can be dispensed with, as would be the case when the cards would be held hanging.

Preferably the card holders are provided with at least a vertically extending edge, so that the cards can be placed on any location along the card holder in order to be retained against movement in horizontal direction transverse to the card: holders.

Preferably the card holders have a slit-shaped accommodation space for receiving an edge of the cards, so that there is question of two vertically extending edges situated at a distance from each other.

Preferably the card holders are straight and elongated. In order to offer the user a maximum number of possibilities to place cards in the card holder it is preferred that the card holders have a profiled shape.

In a further development of the assembly according to the invention the connection means comprise threads or cords and the like. This makes the assembly flexible and it can be rolled up, so that it can be stored away easily. Moreover this keeps the manufacturing costs low. The cords/threads can moreover be easily replaced.

Preferably the threads and the like are connected to the card holders in an adjustable manner. As a result the user is able to adjust the distance between the card holders as desired, to the size of the card. The assembly preferably comprises means for fixing the threads and the like to the card holders in an adjustable manner.

The hanging means comprise threads or cords and the like. These may form a unity with the connection means in an advantageous manner as it is simple regarding construction.

From another aspect the invention provides an assembly for displaying cards, such as greeting cards, comprising a number of elongated card holders suitable for several cards, and flexible, preferably thread-shaped means for connection one to the other of the card holders as well as flexible, preferably thread-shaped means for hanging the assembly on a wall. Such an assembly is easy to turn into a small shape in order to store it away after use—without the possibility of damaging it—.

In an advantageous manner the assembly according to the invention can be adapted for use on two sides, so that one assembly will suffice for two different kind of occasions.

The invention will be elucidated on the basis of an exemplary embodiment shown in the attached drawing, in which:

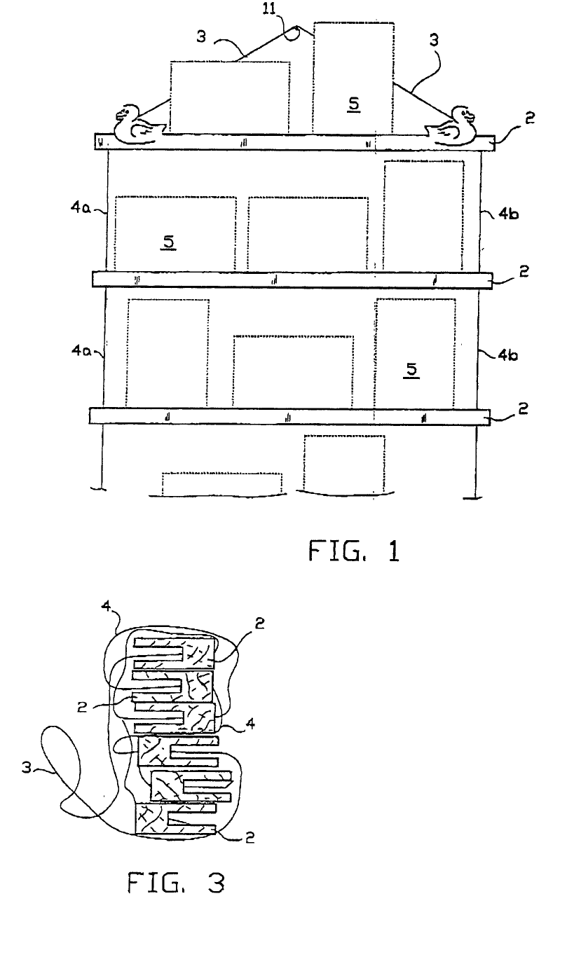

FIG. 1 is a front view of an exemplary embodiment of the assembly according to the invention, in the hung situation;

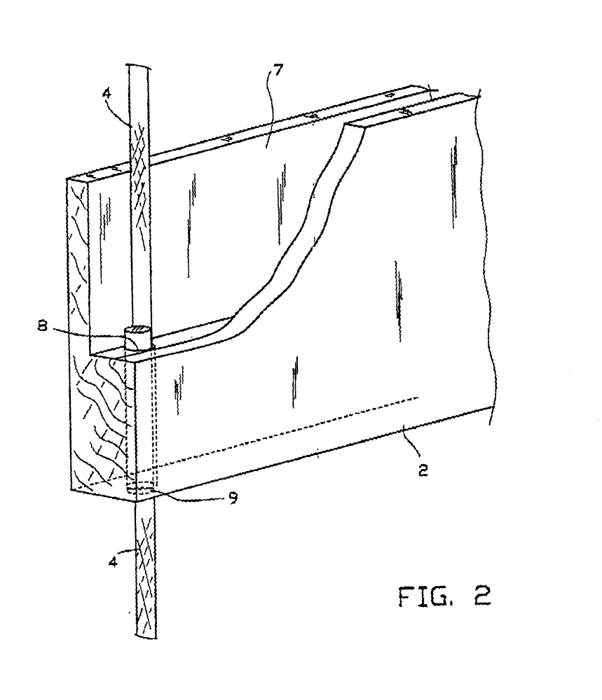

FIG. 2 is the assembly of FIG. 1 in rolled up situation; and

FIG. 3 is a detail at an exaggerated large stale of the assembly according to FIG. 1.

In FIG. 1 an assembly 1 according to the invention is shown, comprising a number of card holders 2 situated above one another, of which the top one at the ends is hung from a hook 11 by means of a decorative thread 3, which hook has been arranged in a wall 10. The card holders 2 that are situated above one another, are connected to each other by means of decorative threads 4a, 4b connected to their ends, such that they hang exactly above each other.

The decorative threads 3 and 4a, 4b may form one continuous whole with each other, in which the attachment of the decorative threads to the card holders 2 is illustrated in FIG. 3, in which it can be seen that the (straight and U-shaped) card holders 2 are provided with a slit 7 arranged over their length and oriented upwards, which slit forms a narrow accommodation space for the cards 5 in order to keep them, stable and straight up. Near the end of the slit 7 in its bottom a hole has been made going through said bottom, through which the decorative thread 4 extends. The decorative thread 4 is secured in the hole 8 with the help of a little wedge 9. If so desired said little wedge 9 can be removed in order to alter the place of the card holder 2 along the decorative thread 4. Alternatively it is also possible to make the fitting of the little wedge 9 such that when exerting a certain tensile force on the decorative thread 4 it may slip over the wanted distance through the hole 8. The decorative thread may be attached to the bottom card holder by means of decorative knots (not shown).

As can be seen in the front view of FIG. 1 the card holders 2 placed above one another offer an attractive matrix-like display of many cards 5, without said cards being hidden behind one another. The card holders 2 here may flatly abut a vertical surface, such a door surface. Attachment of the card holders to that surface may possibly take place with additional screws.

As can also be seen in FIG. 1 the top card holder may be provided on both ends with figures 6, which relate to the theme the cards 5 are related to. Figures 6 may for instance be a Santa or Christmas tree, or alternatively a little baby or stork, in case the birth of child is to be celebrated. Here the figures 6 are formed by little ducks.

It is also possible to use the assembly 1 for several different occasions, for which purpose several card holders may have different colours or be decorated differently on both sides. In case of figures 6, Christmas trees may be provided on the one side and storks on the other side.

The card holders 2 can be made of any suitable material such as for instance wooden fillets.

In case the assembly 1 is not used, the user may simply be able to take it off the wall and stack the card holders or roll them up as shown in FIG. 3. The assembly in that situation takes up very little space and without danger of damage be stored until the next festive occasion.

1. Assembly for displaying cards, such as greeting cards, comprising a number of card holders suitable for several cards, which card holders are situated above each other and at a distance from each other, and means for connecting the card holders one to the other as well as means for hanging the assembly on a wall, in which the card holders are provided with a surface for supporting the cards and at least one vertical extending edge for retaining the cards against movement in horizontal direction transverse to the card holders.

2. Assembly according to claim 1, in which the card holders have a slit-shaped accommodation space for receiving a lower edge of the cards for supporting the cards, said accomodation space being bounded by said at least one vertical extending edge.

3. Assembly according to claim 2, wherein the card holders have an upper edge provided with a slot for accomodating the lower edge of the cards.

4. Assembly according to claim 1, in which the card holders are straight and elongated.

5. Assembly according to claim 4, wherein the card holders are flat.

6. Assembly according to claim 4, in which the card holders have a profiled shape.

6. Assembly according to claim 1, in which the connection means comprise threads or cords and the like.

7. Assembly according to claim 6, in which the threads and the like are connected to the card holders in an adjustable manner.

8. Assembly according to claim 7, furthermore comprising means for fixing the threads and the like to the card holders in an adjustable manner.

9. Assembly according to claim 1, in which the hanging means comprise threads or cords and the like.

10. Assembly according to claim 9, in which the connection means comprise threads or cords and the like, the hanging means forming a unity with the connection means.

11. Assembly according to claim 1, adapted for use on two sides.
